(19) United States
(12) Patent Application Publication
(10) Pub. No.: US 2004/0074541 A1
(43) Pub. Date: Apr. 22, 2004

(54) Flow connector

(76) Inventor: Andrew Sharpe, Cambridge (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/612,524

(22) Filed: Jul. 2, 2003

Related U.S. Application Data
(60) Provisional application No. 60/394,467, filed on Jul. 9, 2002.

(30) Foreign Application Priority Data
Jul. 4, 2002 (GB) 0215431.8
Feb. 26, 2003 (GB) 0304353.6

(51) Int. Cl. F16L 37/32

(52) U.S. Cl. 137/614.04

(57) ABSTRACT

A flow connector comprises first and second flowpath components engageable in an engagement direction. The first and second components have respective ports defining a flow path therebetween. The connector further comprises a sealing member moveable in the engagement direction between a first position between said ports and in said flow path, in which flow between said ports is prevented, and a second position not between said ports and out of said flow path, in which flow between said ports is permitted.

### FIELD OF THE INVENTION

The present invention relates to flow connectors comprising first and second flowpath components engageable in an engagement direction, in particular flow connectors comprising male and female components that interlock in an axial direction thereof, particularly flow connectors of the ‘dry disconnect’ variety in which leakage of fluid on disconnection of the two connector components is reduced to negligible proportions or avoided completely.

### BACKGROUND TO THE INVENTION

Connectors of this kind are known from the tanker industry where they are used to connect flexible hoses. Rotation of a handwheel screws male and female components together in an axial direction and thereafter releases sealing members in both male and female components. Fluid passes around the circumference of these sealing members on its way from an axial inlet to an axial outlet. As will be appreciated, the resistance to flow of such an arrangement can be significant, giving rise to considerable pressure losses and increasing the necessary pumping power. Other connectors of this kind are known, for example, from GB 2 068 069, EP 0 546 745, EP 0 270 302 and U.S. Pat. No. 3,777,771. The present invention has as an objective a fluid connector in which such losses are reduced.

### SUMMARY OF THE INVENTION

Accordingly, in one aspect, the present invention provides a flow connector comprising first and second flowpath components engageable in an engagement direction, the first and second components having respective ports defining a flow path therebetween when connected; the connector further comprising a sealing member moveable in said engagement direction between a first position between said ports and in said flow path, in which flow between said ports is prevented, and a second position not between said ports and out of said flow path, in which flow between said ports is permitted.

Positioning the sealing member of the connector such that it can be located out of the flow path and not between the ports avoids flow around the circumference of the sealing member and the corresponding pressure losses.

Preferably, the first and second components are respectively configured as male and female components which may be mutually engageable in an engagement direction, hereinafter referred to as the axial direction of those male and female components. The sealing member may form part of the male component and may prevent flow through the male component when in its first position, even when disconnected from the female component.

Advantageously, the flow path through one port is in a direction other than said axial direction, preferably predominantly in a direction normal to said axial direction.

The male component may comprise a tubular member insertable in a bore in said female member; said sealing member being moveable to said first position in a bore of said tubular member. Said one port may be formed in the bore in said female member, and the sealing member may be moveable from a first position in said bore of said tubular member to a second position in said bore in said female member, thereby to allow flow through said one port formed in said bore in said female member.

The female member may include a further sealing member, moveable within said bore of said female member to control flow through said one port formed in said bore in said female member. Furthermore, the sealing member and said further sealing member may each form part of respective assemblies, the further sealing member assembly being engageable by the sealing member assembly, thereby to move said further sealing member assembly.

In a particular embodiment, the sealing member may form part of a sealing member assembly comprising a plunger supporting said sealing member, said plunger being tapered in the axial direction, thereby to reduce the resistance to flow through said one port in a direction other than said axial direction. Alternatively or in addition, the sealing member may form part of a sealing member assembly comprising a further tubular member slidably arranged in said tubular member and connected by means of a flat plate to a plunger supporting said sealing member.

In another embodiment, the sealing member may form part of a sealing member assembly comprising a further tubular member slidably arranged in said tubular member and having a further port formed in its circumferential wall, said sealing member being located on said tubular member between said port and one end of the further tubular member. This further tubular member may have a bore having a first portion communicating with said further port and which lies at an angle relative to said axial direction. Advantageously, this angle is in the range 30° to 60°, preferably substantially 45°. Furthermore, the transition between said first portion and a second portion of the bore substantially aligned with said axial direction may be configured so as to reduce flow losses.

Preferably there are substantially no cavities between said sealing member and said further sealing member when respective assemblies are engaged, thereby avoiding retention of fluid after the engagement is broken. In particular, where the sealing member and further sealing member assemblies each have respectively engageable faces, said sealing member and further sealing member may be located adjacent respective faces. These faces may be flat and engage over substantially all their area, thereby avoiding retention of fluid after engagement is broken.

Typically, the sealing member and/or said further sealing member are spring biased towards a position in which fluid flow is prevented.

In preferred embodiments, the flow connector comprises an actuating member for moving the sealing member in the engagement direction. The connector may also comprise a latch configured to secure said first and second components together. Preferably, the actuating member is configured such that, when actuated, it firstly engages said latch means and thereafter moves said sealing member. It is advantageously arranged to be part of the male component, particularly an external collet.

For some applications, the bore of said female member may have a mouth for receiving said male member, and wherein the external profile of said female member tapers away in said axial direction from said region of said female member adjacent said mouth. The member may also include means for attaching said female member to the wall of a fluid channel, which means may be operable from one side only of said wall of a fluid channel, e.g. a screw thread engageable with a corresponding screw thread on said wall.

The invention also comprises individual male and female flow connectors as described above.

In accordance with another aspect, the present invention provides an apparatus for coupling together two lines of a fluid supply, comprising:

first and second connector components engageable in an engagement direction, the first and second connector components each having a port for registration with a respective line of the fluid supply, with engagement of the first and second connector components defining a path for fluid to flow between the ports; and

a sealing member moveable in said engagement direction between a first position in said path for preventing fluid flow between the ports and a second position out of said path for permitting fluid flow between said ports.

### BRIEF DESCRIPTION OF THE DRAWINGS

The invention will now be described by way of example by reference to the following diagrams, of which:

FIGS. 1A and B are sectional views taken along the longitudinal axes of male and female components of a first embodiment of a flow connector according to the present invention;

FIG. 2 illustrates the male and female components of the first embodiment when interlocked

FIGS. 3A and B are detail views of the sealing member assembly of FIGS. 1 and 2;

FIG. 4 is a perspective view of an electronics fluid cooling system incorporating a flow connector according to the present invention;

FIGS. 5A and B are front and side diagrammatic views of a manifold assembly for the system of FIG. 4.

FIGS. 6A and B illustrate a flow connector according to a second embodiment of the invention in disconnected and connected configurations respectively.

### DETAILED DESCRIPTION OF SPECIFIC EMBODIMENTS

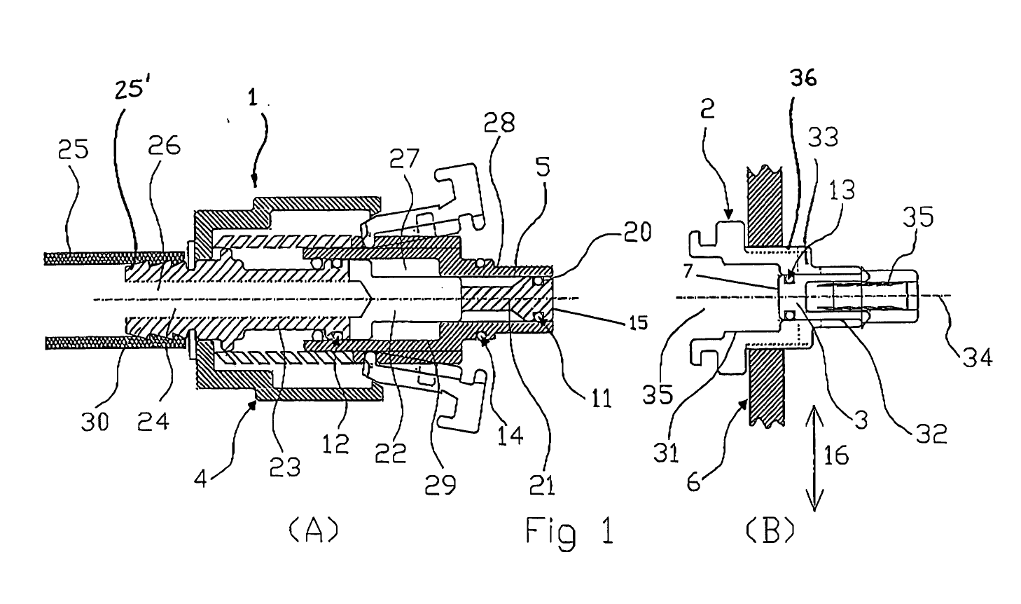

FIG. 1A shows the male component 1 of the connector and comprising a main body 5 housing a central sealing member assembly 30. Main body 5 comprises a first tubular section 28 for insertion into the female component and which is contiguous to (and preferably integral with) a wider tubular section 29. Slideably mounted within each of these two tubular sections is assembly 30, made up of a sealing member (O-ring 11) mounted in a groove 20 formed in a plunger 21. This in turn is connected by means of flat plate member 22 to tubular member 23 which is formed with a conduit 24 itself connected to an axial flow port 26. By means e.g. of a flexible pipe 25 connected to assembly 30 by means of hose barb 25′, fluid is supplied through the axial flow port 26 into a chamber 27 defined by main body 5 and assembly 30. Chamber is sealed at one end by O-ring 11 bearing against the wall of the bore of tubular section 28 and at the other end by a second O-ring 12 bearing against the wall of the bore of wider tubular section 29.

The female component of the connector is illustrated in FIG. 1B and comprises a housing 2 having a first bore 31 having a mouth 35 for reception of the male member 1 and, contiguous therewith, a second bore 32 in which is slidably mounted a plunger 3 sealed against the wall of bore 32 by an O ring 13. To allow flow to/from the connector, bore 32 is formed with ports 33 in a direction other than said axial direction 34, in this case normal to the axial direction. Spring 35 biases plunger 3 to a position in which flow between the holes 33 and bore 31 is prevented by the further sealing member, O ring 13.

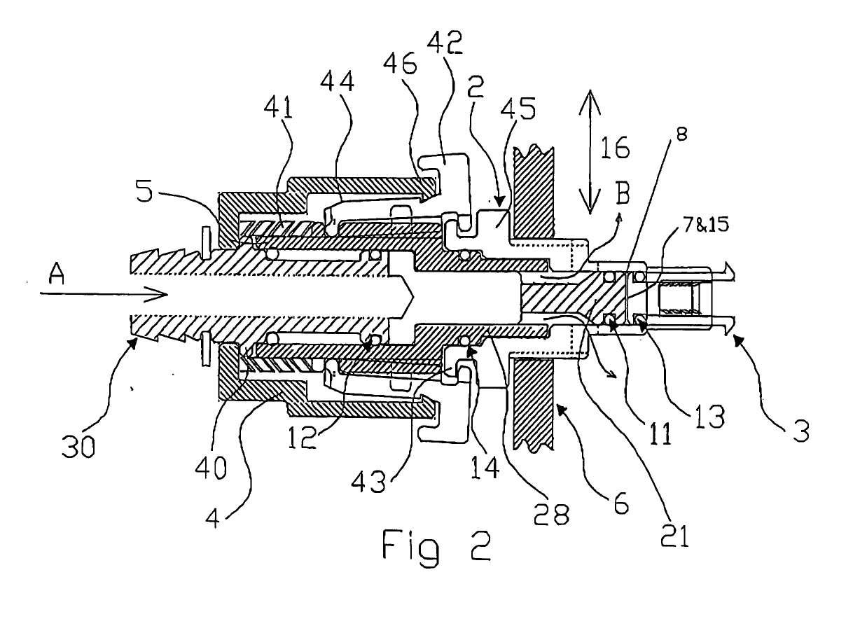

Operation of the connector is illustrated in FIG. 2. Firstly, the main body 5 of the male component 1 is interlocked in an axial direction with the bore 31 of the female component, a fluid seal between the two components being effected by O-ring 14 bearing against the wall of bore 31. Secondly, collet 4 is moved against spring 41, initially forcing latch 42 (by means of cam surface 44) to engage with a flange 43 on the female part.

Once male and female components are securely latched together, further movement engages collet 4 with shoulder 40 of the sealing member assembly 30, sliding the latter inside main body 5 from the first position shown in FIG. 1A to the second position shown in FIG. 2. In this position, the plunger 21 is moved out of the male tubular member 28, allowing flow out of the male component as indicated by arrows B, and sufficiently far into the bore of the female component to allow this flow to pass through ports 33. It will also be noted that in moving to its second position, plunger 21 engages with the corresponding plunger 3 of the female member, forcing this to move back along bore 32 and reveal ports 33. In this way, a flow path is opened between the respective ports.

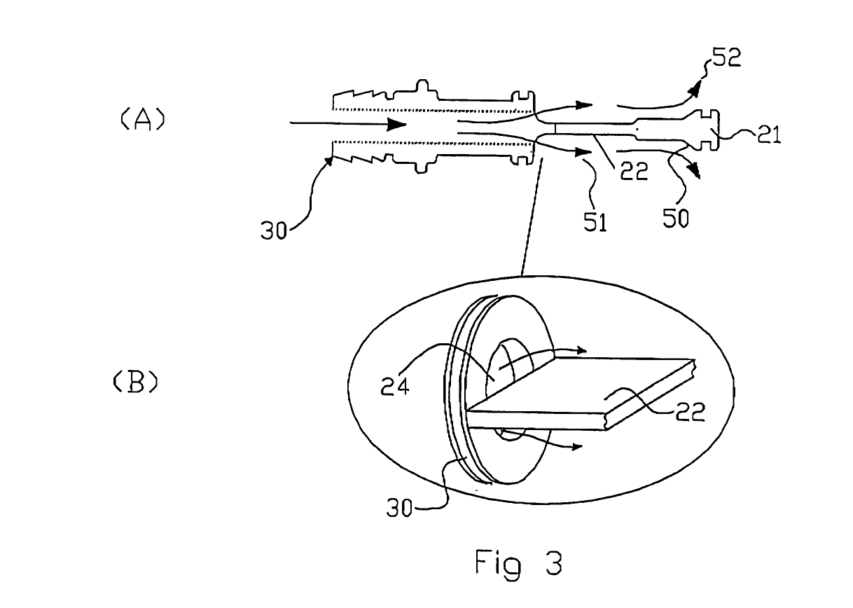

FIG. 3 details by means of arrows the flow through the sealing member assembly 30. Advantageously, plunger 21 is tapered in the axial direction, having a conical form as shown at 50, thereby to reduce the resistance to the transition of flow from axial as shown at 51 to perpendicular as shown at 52. Flow may also be facilitated by generally flat plate member 22 which, as shown in the detail of FIG. 3B, is connected to the remainder of assembly 30 across the mouth of conduit 24, thereby improving structural rigidity and alignment.

Disconnection is achieved by pushing the latch members 42 inwards so as to release catch 46, spring 44 then pulling sealing member assembly 30 backwards into engagement with the bore of tubular member 28, thereby preventing flow. Spring 35 similarly prevents fluid flow through female component 2. Thereafter, the latch is fully released and the connector bodies can be disengaged.

The construction of plungers 3,21 with flat end faces 7, 15 that engage over substantially all their area and O-rings 11,13 positioned adjacent (preferably as close as possible) to those end faces ensures that there are substantially no cavities in which fluid can be retained when respective assemblies are engaged, thereby reducing fluid leakage after the male and female components are disconnected to negligible proportions (just a wetted surface).

Although not restricted in its application, the present invention is particularly suited to arrangements in which the female connector member is mounted on a duct, pipe, manifold, rectangular section pipe 6, tank wall, or other surface. Such an arrangement is shown in FIGS. 1 and 2, the female connector 2 being secured to the wall 6 of a duct by securing means such as a screw thread 36 engaging with a corresponding thread in the wall. Spanner flats may be formed on adjacent collar 45 to facilitate the screwing/tapping process. Preferably, the securing means are configured and the elements of the female member sized so as to facilitate installation of the female member from one side only of the wall, a measure particularly important wherever there is no means of access to the other side of the wall.

A particularly preferred application is in ducts where there is flow transverse to the axis of the connector (as indicated by arrows 16 in FIG. 2). To minimise the resistance to flow in the duct presented by the female member, that part of the female member protruding into the duct is made as slim as possible. This results in an overall shape of the female member that tapers in an axial direction away from its mouth 35.

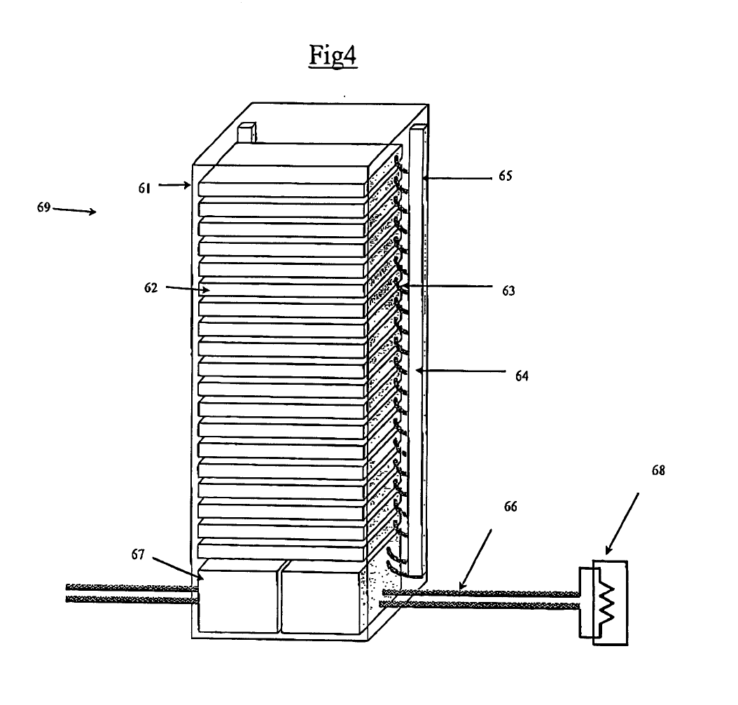

Such a preferred implementation is an electronics fluid cooling system 69 incorporated into a conventional server rack 61 as shown in FIG. 4. Mounted in the rack are electronic apparatus 62 (e.g. server, computer, storage device) each of which has a local cooling circuit discussed in more detail below.

Each local cooling circuit is connected by means of pipes 63 to a ‘global’ cooling circuit 64 comprising a manifold assembly 65 arranged vertically within the side or back panel of the rack and an external radiator/heat exchanger 68. Hot fluid from the local cooling circuits is fed to the heat exchanger 68 and heat transferred to a heat sink (typically the atmosphere, alternatively a chilled water supply) by means of pipes 66. Cooled fluid then returns to a control unit 67 located at the base of the rack and housing a pump for feeding fluid back to the manifold assembly 65.

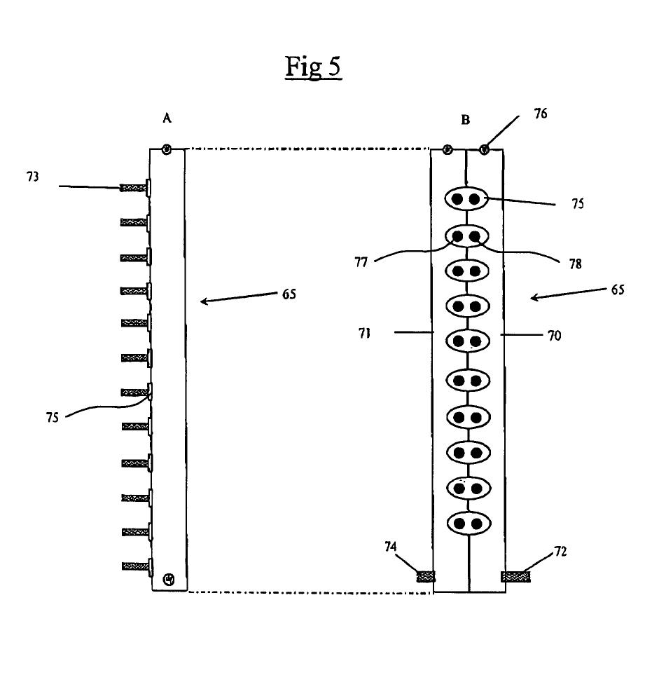

As will be evident from the front and side schematic views of FIGS. 5A and 5B, manifold assembly 65 comprises two individual manifolds or aisles 70, 71. Cold aisle 70 is fed with cold fluid (fluid at a lower temperature than the components it is cooling) from control unit 67 via a pipe 72. Cold aisle 70 is in turn connected in parallel via pipes 73 to each electronic equipment 62 and cold fluid distributed between them. After passing through each equipment 62, the fluid is then directed back to hot aisle 71 and thence (via pipe 74) to control unit 67. From here, the fluid is piped to the fluid inlet of an external radiator 68 to lower the temperature back to cold levels. The fluid then exits the radiator via a fluid outlet, returning to the control unit and passing around the system again. The connections allow electronic equipment to be connected to the manifold via pipes. An electronic equipment is connected to both the cold aisle and the hot aisle. Advantageously, each manifold 70,71 is equipped at its top end with an air release device to remove unwanted air. Alternatively or in addition, the fluid circuit may be operated at a pressure below atmospheric. in the event that the circuit is punctured, this ensures that air is sucked into the circuit rather than fluid leaking out. The release device allows such air to be bled from the circuit.

Flow connectors according to the present invention are shown at 75. Connecting the global fluid circuit 64 and particularly the manifold aisles 70,71 to fluid circuits in respective electronic equipment 62, they provide repeatably-connectable, self-sealing connections which allow individual electronic apparatus to be removed from the rack and other apparatus to be installed in its place. Furthermore, the self-sealing nature of the connection allows this to be achieved without the risk of fluid leakage that would otherwise necessitate a shut down of the entire cooling system whenever an electronic unit was to be replaced. Advantageously, a touch sensor may be embedded in the tip of the plunger of the flow connector, indicating when a connection is made or broken. This in turn will indicate to a control unit how many individual electronic apparatus, e.g. servers, are plugged into the fluid supply at any given time.

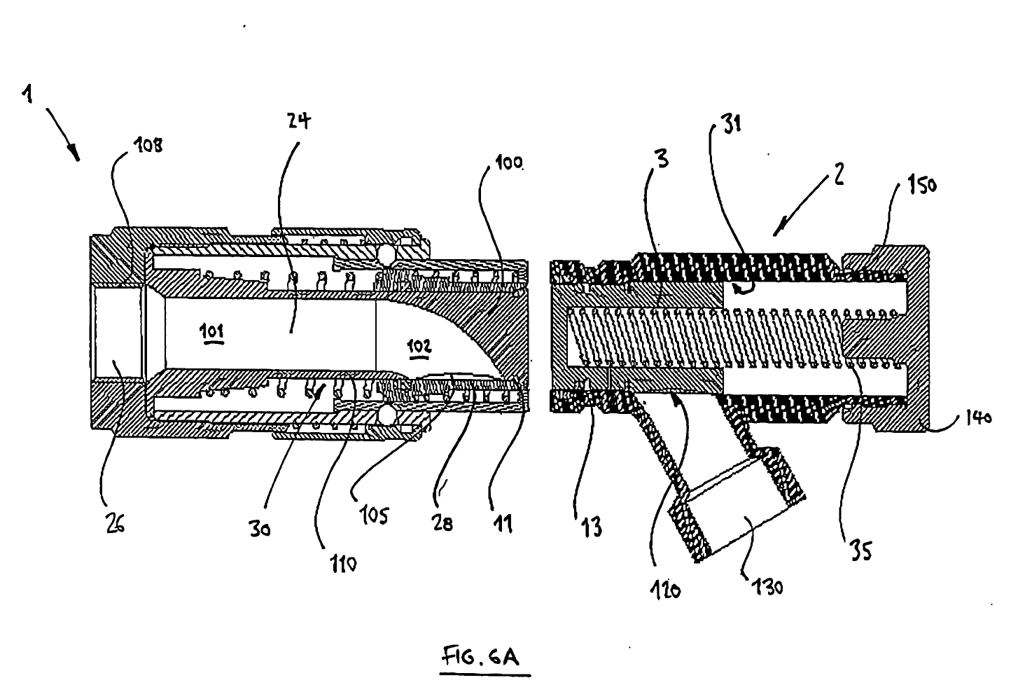

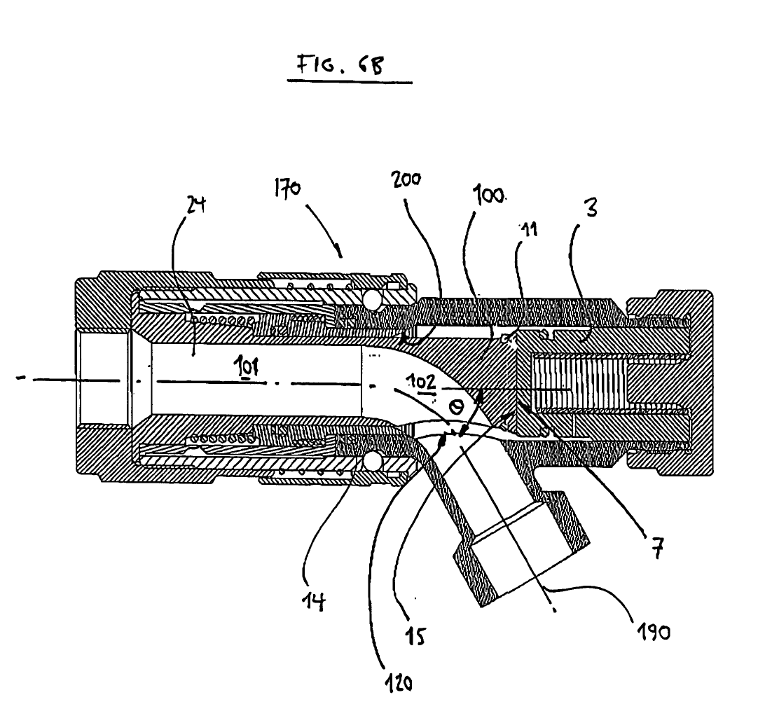

FIGS. 6A and B illustrate a flow connector according to a second embodiment of the invention in disconnected and connected configurations respectively, those elements common with the first embodiment being designated by the same reference figures as used to describe the first embodiment.

Referring to FIG. 6A, the male component 1 of the connector comprises a first tubular section 28 for insertion into the female component. Slideably mounted within tubular section 28 is an assembly 30 made up of a sealing member (O-ring 11) mounted in a groove formed at the end of further tubular member 100. Member 100 is formed with a bore 24 having straight and angled portions 101 and 102. Straight bore portion 101 terminates at one end in an axial flow port 26 for connection e.g. to a flexible fluid pipe (not shown) by means of screw thread 103. Angled bore portion 102 on the other hand terminates in a port 105 formed in the circumferential wall 110 of member 100.

Female connector component comprises a housing 2 having a bore 31 for receiving the tubular section 28 and in which is slidably mounted a plunger 3 sealed against the wall of the bore 31 by an O ring 13. To allow flow to/from the connector, bore 31 has formed in its wall a port 120 communicating with flow port 130 arranged at an angle theta to the axial direction. Port 130 may also be equipped with a screw thread (not shown) for attachment e.g. to a flexible fluid pipe. Spring 35 biases plunger 3 to a position in which flow through port 120 is prevented and is held inside housing 2 by means of an end cap 140 attached e.g. by a screw thread 150.

Operation of the second embodiment of the connector is illustrated in FIG. 6B. Application of force, e.g. manually, initially forces tubular section 28 of the male component 1 into the bore 31 of the female component 2, a fluid seal between the two components being effected by O-ring 14 bearing against outer surface of tubular section 28. Thereafter, tubular member 100 is pushed into bore 31, disengaging O-ring 11 from its seat in the port 200 of the tubular section 28. Face 7 of member 100 also engages the face 15 of plunger 3 and together the two elements 28,3 move to a position to the right-hand side of FIG. 6B in which neither sealing member nor plunger 3 obstructs the flow path 190 between ports 200 and 120 in female member 2. Male and female members are then held in releasable engagement by latch mechanism 170 of the kind well known in the art and consequently not disclosed in any greater detail here.

As with the first embodiment of the invention, the positioning of sealing member 11 out of the flow path 190 facilitates flow. However, the smooth flow path of the second embodiment allows yet further reduction in flow pressure losses, particularly when suitable surface finish, bend angle (theta) and bend radius of the angled portion 102 of bore 24 is chosen. In this regard, angles in the region of 45° have been found to offer a good compromise between commercially-acceptable connector length and connector performance, with angles of exactly 45° having the further advantage of being compatible with conventional pipe fittings. However, in the limit, angles as high as 90° can be used. Alternatively or in addition, good connector performance may be obtained using a ratio of bend radius to bore diameter of substantially 2.

The improved pressure loss characteristics of connectors according to the present invention permit a higher flow or a smaller connector for the same pump power. Connectors of small cross-sectional area also retain less fluid on disconnection, reducing spillage. In addition, the larger bore of the second embodiment reduces the likelihood of blockage from grit, lumps or particulates as well as clogging in the case of glues and paints. The smooth bore of the second embodiment also reduces flow turbulence, important in applications involving beer and aviation fuel, for example.

It should be understood that this invention has been described by way of examples only and that a wide variety of modifications can be made without departing from the scope of the invention as defined by the claims. In particular, the invention is not restricted to the predominantly radial flow directions shown in the example.

1. Flow connector comprising first and second flowpath components engageable in an engagement direction, the first and second components having respective ports defining a flow path therebetween when connected; the connector further comprising a sealing member moveable in said engagement direction between a first position in said flow path, in which flow between said ports is prevented, and a second position out of said flow path, in which flow between said ports is permitted.

2. Flow connector according to claim 1, wherein said first and second components are respectively configured as male and female components.

3. Flow connector according to claim 2, wherein the engagement direction corresponds to an axial direction of said male and female components.

4. Flow connector according to claim 2, wherein said sealing member forms part of said male component.

5. Flow connector according to claim 4, wherein said sealing member prevents flow through said male component when disconnected from the female component.

6. Flow connector according to claim 5, wherein said male component comprises a tubular member insertable in a bore in said female member; said sealing member being moveable to said first position in a bore of said tubular member.

7. Flow connector according to claim 1, wherein the flow path through one of said ports is in a direction other than said engagement direction.

8. Flow connector according to claim 7 wherein said flow path through said one port is predominantly in a direction normal to said engagement direction.

9. Flow connector according to claim 7, wherein said one port is formed in said bore in said female member.

10. Flow connector according to claim 8, wherein said one port is formed in said bore in said female member.

11. Flow connector according to claim 6, wherein said sealing member is moveable from a first position in said bore of said tubular member to a second position in said bore in said female member, thereby to allow flow through said one port formed in said bore in said female member.

12. Flow connector according to claim 11, wherein said female member includes a further sealing member, moveable within said bore of said female member to control flow through said one port formed in said bore in said female member.

13. Flow connector according to claim 12, wherein said sealing member and said further sealing member each form part of respective assemblies, the further sealing member assembly being engageable by the sealing member assembly, thereby to move said further sealing member assembly.

14. Flow connector according to any preceding claim, wherein said sealing member forms part of a sealing member assembly comprising a plunger supporting said sealing member, said plunger being tapered in the engagement direction, thereby to reduce the resistance to flow through said one port in a direction other than said axial direction.

15. Flow connector according to any one of claims 6 to 13, wherein said sealing member forms part of a sealing member assembly comprising a further tubular member slidably arranged in said tubular member and connected by means of a flat plate to a plunger supporting said sealing member.

16. Flow connector according to any one of claims 6 to 13, wherein said sealing member forms part of a sealing member assembly comprising a further tubular member slidably arranged in said tubular member and having a further port formed in its circumferential wall, said sealing member being located on said further tubular member between said further port and one end of the further tubular member.

17. Flow connector according to claim 16, wherein said further tubular member has a bore having a first portion communicating with said further port and which lies at an angle relative to said axial direction.

18. Flow connector according to claim 16, wherein said angle is in a range of from 30° to 60°.

19. Flow connector according to claim 17, wherein said angle is substantially 45°.

20. Flow connector according to claim 17, wherein the bore of said further tubular member has a second portion substantially aligned with said axial direction, the transition between said first and second portions being configured so as to reduce flow losses.

21. Flow connector according to claim 13, wherein there are substantially no cavities between said sealing member and said further sealing member when respective assemblies are engaged, thereby avoiding retention of fluid after the engagement is broken.

22. Flow connector according to claim 21, wherein said sealing member and further sealing member assemblies each have respectively engageable faces, said sealing member being located adjacent the face of said sealing member assembly and said further sealing member being located adjacent the face of said further sealing member assembly.

23. Flow connector according to claim 21, wherein said respectively engageable faces are flat and engage over substantially all their area, thereby avoiding retention of fluid after engagement is broken.

24. Flow connector according to claim 13, wherein at least one of said sealing member and said further sealing member is spring biased towards a position in which fluid flow is prevented.

25. Flow connector according to claim 5 and comprising an actuating member for moving said sealing member in said engagement direction.

26. Flow connector according to claim 25 and comprising a latch configured to secure said first and second components together.

27. Flow connector according to claim 26, wherein said actuating member is configured to engage said latch means and move said sealing member.

28. Flow connector according to claim 27, wherein said actuating member is part of said male component.

29. Flow connector according to claim 28, wherein said actuating member is an external collet.

30. Flow connector according to claim 2, wherein the bore of said female member has a mouth for receiving said male member, and wherein the external profile of said female member tapers away in said axial direction from said region of said female member adjacent said mouth.

31. Flow connector according to claim 2, wherein said female member includes an attachment for attaching said female member to the wall of a fluid channel.

32. Flow connector according to claim 31, wherein said attachment is operable from one side only of said wall of a fluid channel.

33. Flow connector according to claim 32, wherein said attachment is a screw thread engageable with a corresponding screw thread on said wall of a fluid channel.

34. Flow connector comprising male and female flowpath components, the male component comprising a tubular member engageable in an engagement direction with a bore of the female member, the male and female components having respective ports defining a flow path therebetween when connected, the connector further comprising a sealing member moveable in said engagement direction between a first position in the bore of the tubular member and between the ports, in which flow between said ports is prevented, and a second position out of said flow path, in which flow between said ports is permitted, wherein the sealing member forms part of a sealing member assembly comprising a further tubular member slidably arranged in said tubular member and having a further port formed in its circumferential wall, said sealing member being located on said further tubular member between said further port and one end of the further tubular member.
